(19) United States
(12) Patent Application Publication
(10) Pub. No.: US 2024/0311877 A1
(43) Pub. Date: Sep. 19, 2024

(54) GENERATING ITEM RECOMMENDATIONS UTILIZING A DELAYED IN-SITU RECOMMENDATION ENGINE

(71) Applicant: Adobe Inc., San Jose, CA (US)

(72) Inventor: Michele Saad, Austin, TX (US)

(21) Appl. No.: 18/183,023

(22) Filed: Mar. 13, 2023

(51) Int. Cl. G06Q 30/02; G06Q 30/0201; G06Q 30/0601

(52) U.S. Cl. CPC G06Q 30/0281; G06Q 30/0201; G06Q 30/0631

(57) ABSTRACT

The present disclosure relates to systems, non-transitory computer-readable media, and methods for generating and providing recommendations to view items in store by providing item categorization, physical store traffic modelling, historical analysis of returns, and inventory data to a delayed in-situ collaborative filter recommendation engine. In particular, in one or more embodiments, the disclosed systems receive selection of an item to purchase online and pick up in store from a client device. In response, in one or more embodiments, the disclosed systems determine item categorization, accesses physical store traffic modelling, and/or generates an analysis of historical return of items. Further, in one or more embodiments, the disclosed systems utilize a delayed in-situ collaborative filter recommendation engine to determine a recommendation of an additional item to view in store.

### BACKGROUND

Recent years have seen significant improvements in computer systems that categorize and manage physical items. For example, conventional systems have applied various models in a variety of different applications to recommend products to client devices across computer networks. For example, some conventional systems utilize relational models to analyze contents of digital content items to generate digital suggestions for client devices. Although these conventional systems generate item recommendations, they have a number of technical shortcomings, particularly with regard to accuracy, efficiency, and flexibility of implementing computing systems in generating digital recommendations, particularly for delayed in situ viewing.

### BRIEF SUMMARY

One or more embodiments of the present disclosure provide benefits and/or solve one or more problems in the art with systems, non-transitory computer-readable media, and methods for generating a recommendation an item for in-store viewing utilizing a delayed in-situ recommendation system. To illustrate, in one or more embodiments, the disclosed systems determine item categorization, physical store traffic modelling, historical analysis of returns, and inventory data related to a first item selected by a user for later purchase or retrieval. The disclosed systems utilize a delayed in-situ collaborative filter recommendation engine to process the item categorization, physical store traffic modelling, historical analysis of returns, and inventory data to determine a recommendation of a second item to view in store when purchasing or retrieving the first item. Furthermore, the disclosed systems generate a recommendation graphical user interface include a description for the second item that allows the user to accept or decline the recommendation to view the second item.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a delayed in-situ recommendation system operates in accordance with one or more embodiments.

FIG. 2 illustrates an example process for generating a delayed in-situ recommendation in accordance with one or more embodiments.

FIG. 3 illustrates an example delayed in-situ collaborative filter recommendation engine generating a recommendation in accordance with one or more embodiments.

FIG. 4 illustrates an example process for fitting a time series model to a cluster to determine a recommendation in accordance with one or more embodiments.

FIG. 5 illustrates an example recommendation graphical user interface in accordance with one or more embodiments.

FIG. 6 illustrates a schematic diagram of a delayed in-situ recommendation system in accordance with one or more embodiments.

FIG. 7 illustrates a flowchart of a series of acts for generating a delayed in-situ recommendation in accordance with one or more embodiments.

FIG. 8 illustrates a block diagram of an example computing device for implementing one or more embodiments of the present disclosure.

### DETAILED DESCRIPTION

This disclosure describes one or more embodiments of a delayed in-situ recommendation system that generates and provides recommendations to view items in store based on item categorization, physical store traffic modelling, historical analysis of returns, and inventory data. To illustrate, in one or more embodiments, the delayed in-situ recommendation system receives selection of a first item to purchase online and pick up in store from a client device. In response, the delayed in-situ recommendation system determines item categorization, accesses physical store traffic modelling, and/or generates an analysis of historical return of items. In one or more embodiments, the delayed in-situ recommendation system receives and/or utilizes data from a third party system (e.g., a third party system corresponding to the physical store location). In one or more embodiments, the delayed in-situ recommendation system generates a recommendation of an additional item to view in store.

As mentioned, in one or more embodiments, the delayed in-situ recommendation system receives a user selection of an item to purchase online and pick up in store. In one or more embodiments, the delayed in-situ recommendation system receives an indication of the selection from a client device. In one or more embodiments, delayed in-situ recommendation system also receives data associated with the item selection, including a physical store location for picking up the item and/or a time frame for picking up the item.

Additionally, in one or more embodiments, the delayed in-situ recommendation system determines an item categorization for the selected item. In one or more embodiments, the delayed in-situ recommendation system clusters items into categories characterized by similar patterns. For example, in one or more embodiments, the delayed in-situ recommendation system clusters items that tend to be selected together, that attract a similar amount of traffic, that tend to be selected at the similar times of day, week, or year, etc. In one or more embodiments, the delayed in-situ recommendation system determines which cluster to which a selected item belongs.

Further, in one or more embodiments, the delayed in-situ recommendation system accesses physical store traffic modeling for the store corresponding to the item selection. In one or more embodiments, the delayed in-situ recommendation system receives the physical store traffic modeling from a third-party system. In addition, or in the alternative, in one or more embodiments, the delayed in-situ recommendation system utilizes physical store entry data and physical store purchase data to determine a predicted rate of user selection relative to a predicted number of user encounters. Further, in one or more embodiments, the delayed in-situ recommendation system determines a traffic prediction model for the store. Accordingly, in one or more embodiments, the delayed in-situ recommendation system utilizes the traffic prediction model to determine an item selection metric for items in the store.

Also, in one or more embodiments, the delayed in-situ recommendation system generates an analysis of historical return of items. In one or more embodiments, the delayed in-situ recommendation system determines an overall return rate for an item. Additionally, in one or more embodiments, the delayed in-situ recommendation system determines an online purchase return rate. In one or more embodiments, the delayed in-situ recommendation system utilizes these return rates to identify recommendations for items to view in store.

Additionally, in one or more embodiments, the delayed in-situ recommendation system determines an item selection metric utilizing a time series model. To illustrate, the delayed in-situ recommendation system generates the item selection metric utilizing item categorization and physical store traffic modelling in connection with the time series model.

In one or more embodiments, the delayed in-situ recommendation system determines a recommendation of an item to view in the store (e.g., a delayed in-situ item recommendation). To illustrate, in one or more embodiments, the delayed in-situ recommendation system utilizes the item categorization, physical store traffic modelling, historical analysis of returns, and inventory data to generate the delayed in-situ item recommendation. More specifically, in one or more embodiments, the delayed in-situ recommendation system utilizes a delayed in-situ collaborative filter recommendation engine to generate the recommendations based on a variety of factors.

Thus, in one or more embodiments, the delayed in-situ recommendation system generates a recommendation to reserve the item to view in store. In one or more embodiments, the delayed in-situ recommendation system provides the recommendation to the client device that provided the user input selecting the item. In one or more embodiments, the delayed in-situ recommendation system generates the recommendation including selectable options to approve or reject the recommendation.

In one or more embodiments, in response to receiving an indication of approval of the recommendation from the client device, the delayed in-situ recommendation system provides the approval to an administrator device. In one or more embodiments, the administrator device is associated with a third-party system. Accordingly, in one or more embodiments, the delayed in-situ recommendation system ensures that the recommended item is available for the user to view in store when picking up their selected/purchased item.

As alluded to above, conventional systems often generate inaccurate item recommendations. Indeed, most conventional recommendation systems are unable to accurately analyze physical items to determine various relationships between the physical items and/or users. Specifically, conventional recommendation systems are often unable to determine or utilize sufficient contextual information corresponding to physical items to generate accurate predictions for delayed in-situ viewing. In turn, without sufficient context, the conventional recommendation systems often provide inapplicable recommendations to users based on an inaccurate predictions of user interest, and/or attributes of the recommended items.

With inaccurate relation predictions perpetuating inaccurate or inapplicable suggested items, conventional recommendation systems are also prone to waste computing resources. For example, conventional recommendation systems expend significant computing resources and system bandwidth in generating, transmitting, and surfacing inaccurate suggestions or recommendations to client devices. In addition, because of these inaccurate suggestions, conventional systems also often require significant user interactions to locate and identify desired digital content.

In addition, conventional recommendation systems are often rigid and inflexible. For example, many conventional recommendation systems utilize models that are tied to a specific and rigid data structure. To illustrate, some conventional recommendation systems often analyze historical user selections and generate recommendations utilizing these specific historical selections. This rigid approach, however, fails to analyze the wide variety of available information for in determining pertinent data regarding physical items. This rigidity only exacerbates the accuracy and efficiency problems outlined above.

The delayed in-situ recommendation system provides advantages and benefits over conventional systems. For example, the delayed in-situ recommendation system increases the accuracy of predictions relative to conventional systems. Indeed, in one or more embodiments, the delayed in-situ recommendation system utilizes a delayed in-situ collaborative filter recommendation engine that utilizes a variety of data giving context to various items to recommend. As mentioned above, in one or more embodiments, the delayed in-situ collaborative filter recommendation engine utilizes item categorization, physical store traffic modelling, historical analysis of returns, and/or inventory data.

Further, the delayed in-situ recommendation system improves efficiency relative to conventional systems. To illustrate, in one or more embodiments, the delayed in-situ recommendation system clusters items based on similar historical patterns of user selection. Accordingly, in one or more embodiments, the delayed in-situ recommendation system improves efficiency relative to conventional systems by evaluating items within a cluster rather than evaluating all available items for a location. By evaluating a cluster corresponding to a selected item, the delayed in-situ recommendation system saves time and computing resources. Further, the improved accuracy of the delayed in-situ recommendation system increases efficiency by eliminating or reducing excess computing resources consumed generating and rejecting inaccurate recommendations.

The delayed in-situ recommendation system provides improvements in accuracy, efficiency, and flexibility in generating delayed in situ item recommendations. For example, the delayed in situ, particularly for delayed in situ viewing improves flexibility relative to conventional systems. Indeed, in one or more embodiments, the delayed in-situ recommendation system flexibly uses a variety of contextual data regarding selected and recommended items. By utilizing this variety of information, the delayed in-situ recommendation system flexibly generates accurate recommendations in a variety of situations.

As illustrated by the foregoing discussion, the present disclosure utilizes a variety of terms to describe features and advantages of the delayed in-situ recommendation system. Additional detail is now provided regarding the meaning of such terms. For example, as used herein, the term “item” refers to an object. In particular, an item, in one or more embodiments, includes a physical object corresponding to a virtual representation (e.g., in an online storefront). To illustrate, an item, in one or more implementations, includes a physical object available for purchase at a particular physical store.

Additionally, as used herein, the term “item categorization” refers to a grouping of items. In particular, as item categorization refers to a groupings of items based on similar historical patterns of selection or other factors. To illustrate, an item categorization includes a grouping of items with similar selection, return, and/or purchase patterns. Relatedly, as used herein, the term “cluster” refers to a group of items in an item categorization.

Further, as used herein, the term “physical store traffic modeling” refers to analysis of user encounters and user selections of an item at a physical location. In particular, the term physical store traffic modeling includes determining an item selection metric based on a rate of user selection of the item relative to a predicted number of user encounters. To illustrate, physical store traffic modeling includes general or specific traffic prediction models and/or time-series traffic forecasting models.

Also, as used herein, the term “delayed in-situ collaborative filter recommendation engine” refers to a computational system that generates delayed in-situ item recommendations based on selected items. In particular, the term delayed in-situ collaborative filter recommendation engine utilizes an optimization algorithm for an item selection metric. To illustrate, in one or more embodiments, the delayed in-situ collaborative filter recommendation engine utilizes item categorization, physical store traffic modelling, historical analysis of returns, and inventory data to determine a delayed in-situ item recommendation. In one or more embodiments, the delayed in-situ collaborative filter recommendation engine determines the delayed in-situ item recommendation by maximizing a likelihood of selection and/or minimizing a likelihood of return. Relatedly, as used herein, the term “item selection metric” refers to a score reflecting a likelihood of approval or acceptance of a delayed in-situ recommendation of an item.

Additionally, as used herein, the term “inventory data” refers to information about items available at a store. In particular, the term inventory includes one or more of stocking information, shipment information, or predictions associated with future stocking information and/or shipment information. To illustrate, in one or more embodiments, inventory data includes data reflecting current availability of one or more items and/or predictions regarding future availability of the one or more items.

Further, used herein, the term “recommendation,” “item recommendation” or “delayed in-situ item recommendation” refers to an indication or prompt presenting an item for selection for later viewing. In particular, a delayed in-situ item recommendation, in one or more embodiments, includes a digital message or prompt providing and/or suggesting an item for selection and later viewing/sampling. To illustrate, a delayed in-situ item recommendation comprises a graphical user interface overlay or message presenting an item, information about the recommended item, and information about trying and/or picking up the recommended item.

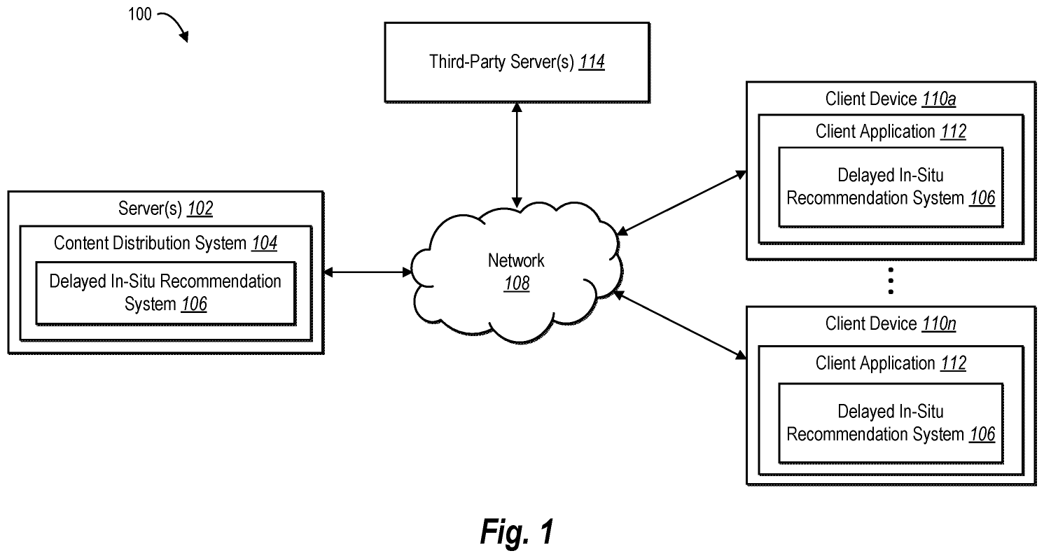

Additional detail will now be provided in relation to illustrative figures portraying example embodiments and implementations of the persona group system. For example, FIG. 1 illustrates a schematic diagram of an exemplary system 100 in which a delayed in-situ recommendation system 106 operates. As illustrated in FIG. 1, the system 100 includes a server(s) 102, a network 108, client devices 110a-110n, and a third-party server(s) 114.

Although the system 100 of FIG. 1 is depicted as having a particular number of components, the system 100 is capable of having any number of additional or alternative components (e.g., any number of servers, client devices, third-party servers, or other components in communication with the delayed in-situ recommendation system 106 via the network 108). Similarly, although FIG. 1 illustrates a particular arrangement of the server(s) 102, the network 108, the client devices 110a-110n, and the third-party server(s) 114, various additional arrangements are possible.

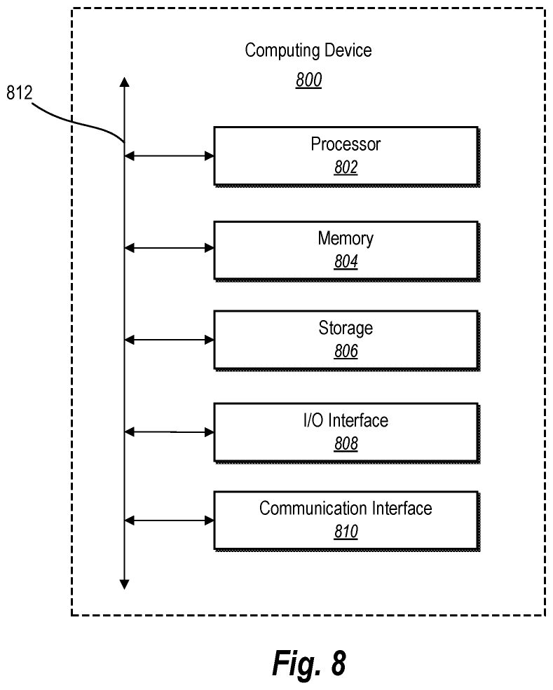

The server(s) 102, the network 108, the client devices 110a-110n, and the third-party server(s) 114 are communicatively coupled with each other either directly or indirectly (e.g., through the network 108 discussed in greater detail below in relation to FIG. 8). Moreover, the server(s) 102, the client devices 110a-110n, and the third-party server(s) 114 include one or more of a variety of computing devices (including one or more computing devices as discussed in greater detail with relation to FIG. 8).

As mentioned above, the system 100 includes the server(s) 102. In one or more embodiments, the server(s) 102 generates, stores, receives, and/or transmits data including digital data related to user selections, item categorization, physical store traffic modeling, historical return data, inventory data, etc. In one or more embodiments, the server(s) 102 comprises a data server. In some implementations, the server(s) 102 comprises a communication server or a web-hosting server.

In one or more embodiments, the content distribution system 104 manages the distribution of digital content to client devices (e.g., the client devices 110a-110n). For example, in some instances, the content distribution system 104 distributes digital content related to digital items from a catalog of digital items. In some implementations, the content distribution system 104 distributes digital content for display via one or more digital platforms that are accessed by the client devices.

In one or more embodiments, the third-party server(s) 114 interacts with the delayed in-situ recommendation system 106, via the server(s) 102, over the network 108. For example, in some implementations, the third-party server(s) 114 hosts a digital platform that provides digital content to display from the delayed in-situ recommendation system 106 based on user selections, item categorization, physical store traffic modeling, historical return data, inventory data, etc. Further, in some cases, the third-party server(s) 114 interacts with the client devices 110a-110n and provides data regarding the interactions to the delayed in-situ recommendation system 106.

Additionally, in one or more embodiments, the client devices 110a-110n include computing devices that access digital platforms and/or display digital content. For example, the client devices 110a-110n include smartphones, tablets, desktop computers, laptop computers, head-mounted-display devices, or other electronic devices. The client devices 110a-110n include one or more applications (e.g., the client application 112) that access digital platforms and/or display digital content. For example, in one or more embodiments, the client application 112 includes a software application installed on the client devices 110a-110n. Additionally, or alternatively, the client application 112 includes a web browser or other application that accesses a software application hosted on the server(s) 102 (and supported by the content distribution system 104).

To provide an example implementation, in one or more embodiments, the delayed in-situ recommendation system 106 on the server(s) 102 supports the delayed in-situ recommendation system 106 on the client device 110n. For instance, in some cases, the delayed in-situ recommendation system 106 on the server(s) 102 identifies digital items for presentation to a client device for in-store viewing. The delayed in-situ recommendation system 106 then, via the server(s) 102, communicates the digital items to the client device 110n. The delayed in-situ recommendation system 106 on the client device 110n submits a recommendation for the digital items for display via a digital platform. In some cases, the delayed in-situ recommendation system 106 on the client device 110n further receives and displays the requested digital content.

In alternative implementations, the delayed in-situ recommendation system 106 includes a web hosting application that allows the client device 110n to interact with content and services hosted on the server(s) 102. To illustrate, in one or more implementations, the client device 110n accesses a software application supported by the server(s) 102 (e.g., via the digital platform 116 hosted on the third-party server(s) 114). In response, the delayed in-situ recommendation system 106 on the server(s) 102 identifies items to recommend for in-store viewing. The server(s) 102 then provides digital content related to the digital items that are recommended to view in-store on the client device 110n (e.g., via the digital platform 116).

Indeed, the delayed in-situ recommendation system 106 is able to be implemented in whole, or in part, by the individual elements of the system 100. Indeed, although FIG. 1 illustrates the delayed in-situ recommendation system 106 implemented with regard to the server(s) 102, different components of the delayed in-situ recommendation system 106 are able to be implemented by a variety of devices within the system 100. For example, in some cases, one or more (or all) components of the delayed in-situ recommendation system 106 are implemented by a different computing device (e.g., one of the client devices 110a-110n) or a separate server from the server(s) 102 hosting the content distribution system 104 (e.g., the third-party server(s) 114). Indeed, as shown in FIG. 1, the client devices 110a-110n include the delayed in-situ recommendation system 106. Example components of the delayed in-situ recommendation system 106 will be described below with regard to FIG. 8.

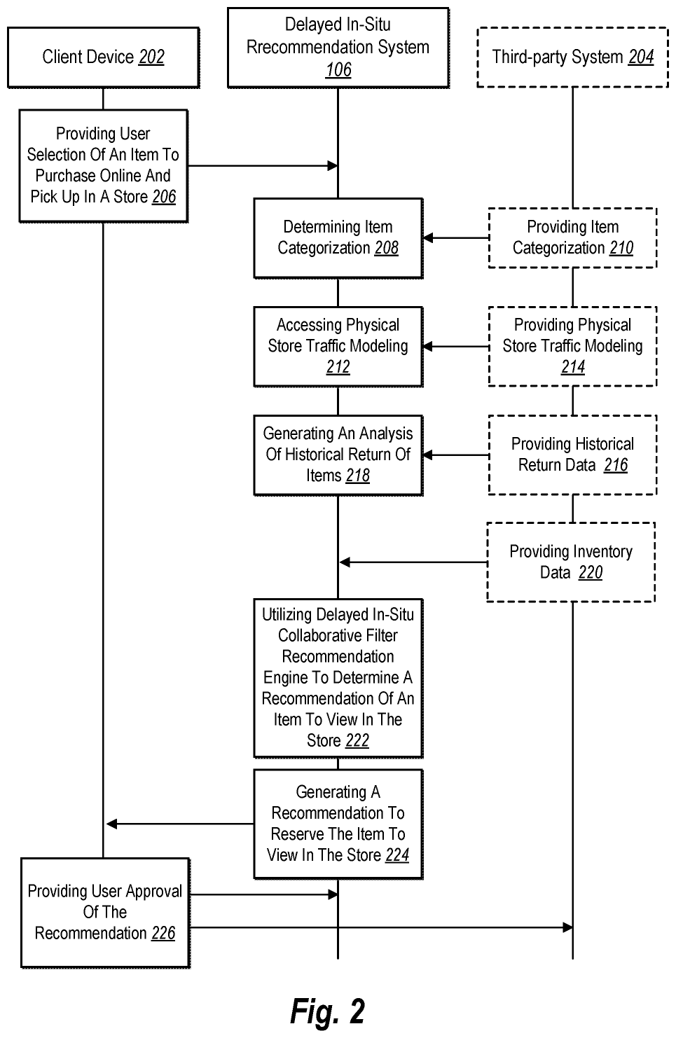

As discussed above, the delayed in-situ recommendation system 106 generates recommendations to reserve items utilizing a delayed in-situ collaborative filter recommendation engine. For instance, FIG. 2 illustrates the system generating and providing recommendations for items to view in store in accordance with one or more embodiments. Specifically, FIG. 2 illustrates a client device 202, a delayed in-situ recommendation system 106, and an optional third-party system 204.

As shown in FIG. 2, the client device 202 performs an act 206 of providing a user selection of an item to purchase online and pick up in a store. In one or more embodiments, the client device 202 receives an indication of adding an item to a cart and/or user selection finalizing a purchase to pick up in store. As shown in FIG. 2, the client device 202 provides the user selection to the delayed in-situ recommendation system 106.

Further, in FIG. 2, the delayed in-situ recommendation system 106 performs an act 208 of determining an item categorization. In one or more embodiments, as shown in FIG. 2, the third-party system 204 performs an optional act 210 of providing the item categorization to the delayed in-situ recommendation system 106. In addition, or in the alterative, the delayed in-situ recommendation system 106 determines the item categorization. In one or more embodiments, the delayed in-situ recommendation system 106 utilizes a machine learning model to determine item categorization. For example, in one or more embodiments, the delayed in-situ recommendation system 106 utilizes a clustering model.

In one or more embodiments, the physical store traffic modeling includes a predictive model that forecasts the overall traffic for a physical store location. For instance, the delayed in-situ recommendation system 106 utilizes a probabilistic time-dependent stochastic process to determine physical store traffic modeling. In one or more embodiments, the delayed in-situ recommendation system 106 utilizes a Poisson process to determine the physical store traffic modeling. In one or more embodiments, the delayed in-situ recommendation system 106 utilizes a Poisson model to determine likely foot traffic and patterns of behavior of individuals inside physical locations. Accordingly, in one or more embodiments, the delayed in-situ recommendation system 106 determines items that individuals are likely to encounter and a rate of encounter for those items over a period of time.

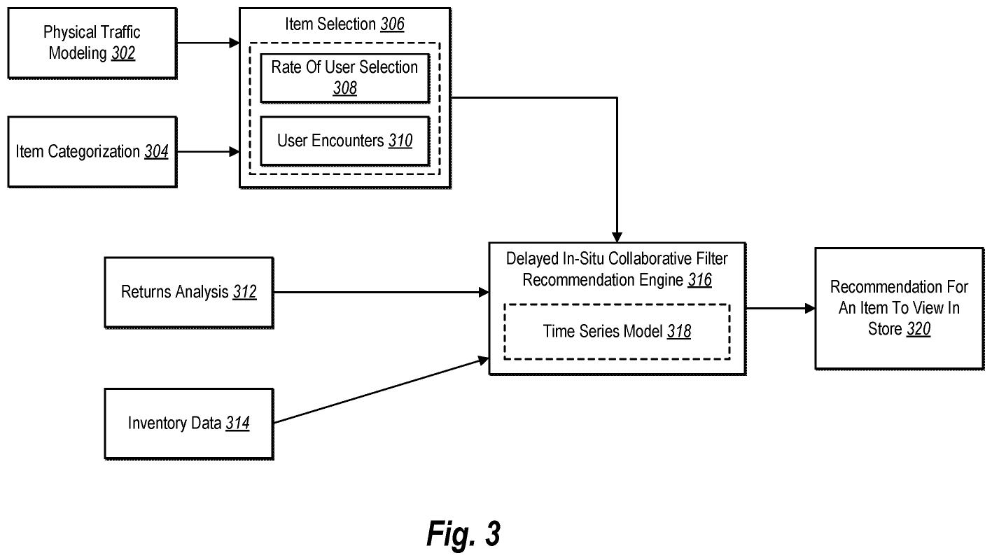

In one or more embodiments, the delayed in-situ recommendation system 106 utilizes the item categorization and/or the physical store traffic modeling to generate item selection metrics. In one or more embodiments, the delayed in-situ recommendation system 106 determines item selection metrics utilizing a traffic prediction model for each item corresponding to the physical store location. As will be discussed below with regard to FIG. 3, in one or more embodiments, the delayed in-situ recommendation system 106 derives the traffic prediction model as a function of the physical store traffic modeling and modulated by a time-series traffic forecasting model. In one or more embodiments, the delayed in-situ recommendation system 106 derives the traffic forecasting model as a function of the item clusters.

As also shown in FIG. 2, the delayed in-situ recommendation system 106 performs an act 218 of generating an analysis of historical return of items. In one or more embodiments, as shown in FIG. 2, the third-party system 204 performs an optional act 216 of providing the historical return data to the delayed in-situ recommendation system 106. In one or more embodiments, the delayed in-situ recommendation system 106 identifies items purchased online with a high return rate and with a high probability of the return being as a result of an online purchase process.

For example, in one or more embodiments, the delayed in-situ recommendation system 106 determines return metrics in its analysis of historical return of items by determining user preference for an item in-store compared to online. For example, in one or more embodiments, the delayed in-situ recommendation system 106 determines this metric utilizing survey data indicating reasons for return. In one or more embodiments, the delayed in-situ recommendation system 106 analyzes return survey data to determine whether candidate items are items returned due to unmet expectations, sizing issues, incomplete online listing information, or other problems not evident online purchase. In addition, or in the alternative, the delayed in-situ recommendation system 106 determines return metrics by comparing a rate of return for the item when purchased online to a rate of return for the item when purchased in-store.

Further, the third-party system 204 performs an optional act 220 of providing inventory data. In one or more embodiments, the delayed in-situ recommendation system 106 accesses inventory data directly. In one or more embodiments, the delayed in-situ recommendation system 106 provides the inventory data to a delayed in-situ collaborative filter recommendation engine.

As further shown in FIG. 2, the third-party system 204 performs an act 222 of utilizing a delayed in-situ collaborative filter recommendation engine to determine a recommendation of an item to view in the store. To illustrate, as mentioned above, the delayed in-situ recommendation system 106 provides the item selected at the act 206 and corresponding item categorizations, physical store traffic modeling, item selection metrics, analyses of historical returns, and/or inventory data to a delayed in-situ collaborative filter recommendation engine. In one or more embodiments, the delayed in-situ recommendation system 106 utilizes the delayed in-situ collaborative filter recommendation engine to determine an additional item to recommend for viewing in store when picking up the item in store.

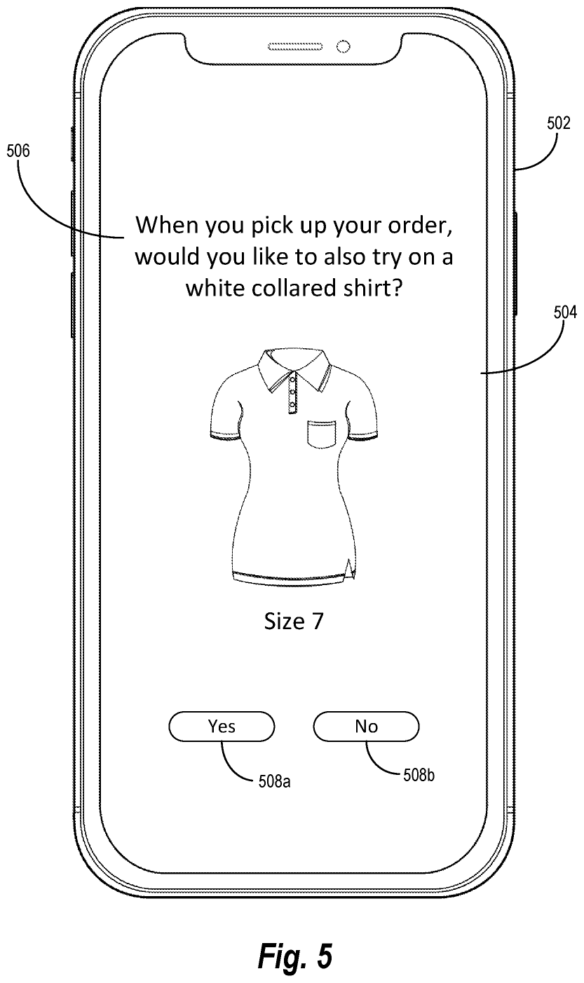

In one or more embodiments, the delayed in-situ recommendation system 106 performs an act 224 of generating a recommendation to reserve the additional item to view in the store. As will be discussed in greater detail below with regard to FIG. 5, the delayed in-situ recommendation system 106, in one or more implementations, generates and provides a graphical user interface recommending the determined item for in-store viewing. In one or more embodiments, the delayed in-situ recommendation system 106 generates the recommendation including information and/or images corresponding to the determined item. Additionally, in one or more embodiments, the recommendation includes interactable elements for approving or declining the recommendation.

As also shown in FIG. 2, the client device 202 performs an act 226 of providing user approval of the recommendation. To illustrate, in one or more embodiments, in response to detecting user interaction indicating user approval of the recommendation, the client device 202 provides an indication of the user approval to the delayed in-situ recommendation system 106 and/or the third-party system 204. In one or more embodiments, the delayed in-situ recommendation system 106 generates instructions to provide to a client device 202 at the physical store location to set aside the recommended item for in-store viewing associated with the in-store pick-up of the item selected at the act 206.

As mentioned above, in one or more embodiments, the delayed in-situ recommendation system 106 utilizes a delayed in-situ collaborative filter recommendation engine to determine recommendations for items to view in-store. FIG. 3 illustrates an example delayed in-situ collaborative filter recommendation engine 316. More specifically, FIG. 3 illustrates the delayed in-situ collaborative filter recommendation engine 316 receiving and utilizing various data to generate recommendations.

To illustrate, in one or more embodiments, the delayed in-situ recommendation system 106 utilizes physical traffic modeling 302 and item categorization 304 to determine an item selection 306. In one or more embodiments, the delayed in-situ recommendation system 106 utilizes an item selection prediction model to determine an item selection metric. As shown in FIG. 3, the item selection 306 includes an optional rate of user selection 308 and user encounters 310.

As discussed above, the physical traffic modeling 302 includes a predictive model that forecasts traffic for a physical store. In one or more embodiments, the physical traffic modeling 302 is a time-dependent stochastic process such as a Poisson process. In one or more embodiments, the delayed in-situ recommendation system 106 provides the predictions from the physical traffic modeling 302 to the item selection 306.

As also mentioned above, the item categorization 304 includes item clusters corresponding to various items available for selection. In one or more embodiments, the delayed in-situ recommendation system 106 applies a clustering model to items in a catalogue or listing corresponding to a digital retailer and/or corresponding physical location(s). In one or more embodiments, the delayed in-situ recommendation system 106 clusters the items into categories characterized by similar traffic behaviors. For example, the delayed in-situ recommendation system 106 clusters items together that tend to be bought together, that attract a similar amount of traffic, that adhere to similar trends, that are selected at similar dates or times, and other traffic patterns.

In one or more embodiments, the item selection 306 is an item selection module that generates item selection metrics. In one or more embodiments, the delayed in-situ recommendation system 106 determines a traffic prediction model for each item as a function of the physical traffic modeling 302. To illustrate, the delayed in-situ recommendation system 106 utilizes predicted traffic for each item from the physical traffic modeling 302. In one or more embodiments, the delayed in-situ recommendation system 106 modulates the predicted traffic for each item by a time-series traffic forecasting model and derived as a function of the item categorizations received from the item categorization 304.

In addition, or in the alternative, as shown in FIG. 3, the item selection 306 includes the optional rate of user selection 308 and the optional user encounters 310. In one or more embodiments, the delayed in-situ recommendation system 106 determines the rate of user selection 308 for an item based on the item categorization 304. Further, in one or more embodiments, the delayed in-situ recommendation system 106 determines a number of user encounters 310 based on the physical store traffic modeling. Accordingly, the delayed in-situ recommendation system 106 multiplies the rate of user selection 308 and the predicted number of user encounters 310 to determine a predicted rate of item selection per unit of time. In one or more embodiments, the item selection module generates an item selection metric based on this predicted rate of item selection per unit of time.

As shown in FIG. 3, the item selection 306 provides item selection metrics to the delayed in-situ collaborative filter recommendation engine. As also shown in FIG. 3, the delayed in-situ recommendation system 106 provides returns analysis 312 to the delayed in-situ collaborative filter recommendation engine 316. Additionally, in one or more embodiments, the delayed in-situ recommendation system 106 provides inventory data to the delayed in-situ collaborative filter recommendation engine 316. In one or more embodiments, the delayed in-situ recommendation system 106 also provides an indication of the user selection of an item to purchase online and pick-up in-store to the delayed in-situ recommendation system 106.

As shown in FIG. 3, in one or more embodiments, the delayed in-situ collaborative filter recommendation engine utilizes a time series model 318. In one or more embodiments, the delayed in-situ collaborative filter recommendation engine utilizes the time series model 318 to optimize the efficiency of recommendations by accounting for the limitations and strengths of purchasing online and picking up in store. To illustrate, by utilizing an item's rate of return for online purchases relative to in-store purchases the delayed in-situ collaborative filter recommendation engine 316 is able to reduce the return rate of items that do not meet online expectations and/or that have a high rate of return due to insufficient online information. Further, by maximizing the likelihood of selection of an item subject to the predicted availability of the item, the delayed in-situ collaborative filter recommendation engine 316 minimizes the risk of holding items that are likely to run out of stock based on inventory information, physical store traffic modeling, and selection rates.

In one or more embodiments, the delayed in-situ collaborative filter recommendation engine 316 generates item recommendations utilizing an optimization equation. More specifically, in one or more embodiments, the delayed in-situ collaborative filter recommendation engine 316 utilizes an optimization algorithm in which:

Let v(t) be the distribution of traffic to the physical store as a function of time t. An example of v is the Poisson distribution. The distribution from the physical-store traffic data is derived from the block called.

Let cᵢ∈C={c₁, c₂, . . . c_{N}} be the catalog category to which item i (e.g., an item selected by a user) belongs to, where there are N categories that categorize items by their popularity. For instance, category c₁ could represent the group of items that have the highest selling rate, and CN could be the category of items of lowest popularity.

Let e; be a multiplicative factor modulating the probability of items selling at the physical store at any given day.

Let r(k) be the likelihood that an item k is returned due to unmet expectations as a result of being purchased online.

Let s(k) be the score representing the likelihood item k is to be of interest to the specific user who selected the item i.

Then, where I,(i) is the inventory count of item k at time t, the delayed in-situ collaborative filter recommendation engine 316 determines the recommendation of an item to view in the store utilizing:

$$\begin{matrix}maximize k & \frac{s ( k ) r ( k )}{{e}_{{c}_{i}} v ( t )} \\ subject to & {e}_{{c}_{i}} v ( t ) < It ( i )\end{matrix} \qquad ( 1 )$$

In one or more embodiments, the delayed in-situ collaborative filter recommendation engine 316 generates a recommendation for an item to view in store 320. In one or more embodiments, the delayed in-situ recommendation system 106 utilizes the delayed in-situ collaborative filter recommendation engine 316 to identify an item from the listing, catalogue, and/or clusters corresponding to a physical location for in-store viewing. As mentioned, in one or more embodiments, the delayed in-situ collaborative filter recommendation engine 316 selects the item the highest probability of selection by the user, both when prompted to reserve the item and when picking up in-store.

By utilizing the optimization algorithm above, the delayed in-situ recommendation system 106 is able to generate recommendations that are specific for a delayed in-situ viewing. In one or more embodiments, the delayed in-situ collaborative filter recommendation engine 316 generates a recommendation for an item to view in store that reduces the risk of missed purchase opportunities at the physical store when an item is put on hold between the time an online purchase is made, and the shopper arrives at the store for pick up. Additionally, in one or more embodiments, the delayed in-situ recommendation system 106 models traffic at physical stores and purchase rate prediction associated with each item or groups of items (for scalability). Further, the delayed in-situ recommendation system 106 utilizes automatic identification of items that lend themselves better for purchase at a physical store versus online store. Also, the delayed in-situ recommendation system 106 utilizes automatic incorporation of return information associated with each item; this includes the rate of returns associated with each product and whether that return was associated with an online or a physical store purchase. Still further, the delayed in-situ recommendation system 106 utilizes automatic incorporation of textual data from return orders that sometimes contain clues as to whether the return was due to unmet expectations due to the online experience.

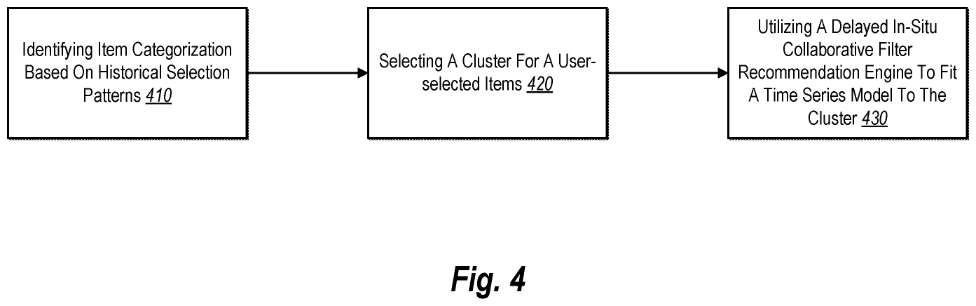

As mentioned above, the delayed in-situ recommendation system 106 utilizes a delayed in-situ collaborative filter recommendation engine including a time series model. FIG. 4 illustrates a method for utilizing item categorization in conjunction with a time series model. More specifically, in one or more embodiments, the delayed in-situ recommendation system 106 utilizes a time series model as part of a delayed in-situ collaborative filter recommendation engine to determine recommendations for an item to view in store.

To illustrate, in one or more embodiments, the delayed in-situ recommendation system 106 performs an act 410 of identifying item categorization based on historical selection patterns. In one or more embodiments, the delayed in-situ recommendation system 106 clusters items utilizing a clustering model. In one or more embodiments, the delayed in-situ recommendation system 106 applies the clustering model to items corresponding to a physical location that corresponds to an item selected to purchase online and pick-up at the physical location. In one or more embodiments, the delayed in-situ recommendation system 106 clusters the items based on similar traffic behaviors in historical selection. For example, the delayed in-situ recommendation system 106 analyzes the historical selection pattern to cluster items together that tend to be bought together, that attract a similar amount of traffic, that adhere to similar trends, that are selected at similar dates or times, and other traffic patterns.

Additionally, in one or more embodiments, the delayed in-situ recommendation system 106 performs an act 420 of selecting a cluster for a user-selected item. To illustrate, in one or more embodiments, the delayed in-situ recommendation system 106 determines a cluster to with the user-selected item corresponds. In one or more embodiments, the delayed in-situ recommendation system 106 identifies an additional item to recommend for in-store viewing from the same cluster to which the user-selected item belongs.

Further, in one or more embodiments, the delayed in-situ recommendation system 106 performs an act 430 of utilizing a delayed in-situ collaborative filter recommendation engine to fit a time series model to the cluster. To illustrate, in one or more embodiments, the delayed in-situ recommendation system 106 fits a time series model to the cluster corresponding to the user-selected item. As discussed above, with regard to the item selection module, the delayed in-situ recommendation system 106 fits a time series model to various items to determine an item recommendation for in-store viewing. To improve efficiency, in one or more embodiments, the delayed in-situ recommendation system 106 fits the time series model to items within the selected cluster in order to conserve time and computing resources while maintaining accuracy.

In one or more embodiments, the delayed in-situ recommendation system 106 provides a recommendation of an item to view in store to a client device. FIG. 5 illustrates an example graphical user interface for providing a recommendation. More specifically, FIG. 5 illustrate a client device 502 displaying a graphical user interface 504.

As shown in FIG. 5, the graphical user interface 504 includes a recommendation 506 including the text “When you pick up your order, would you like to also try on a white collared shirt?” The recommendation 506 also includes an image of the recommended item (i.e., a collared shirt and the text “Size 7”). However, it will be appreciated that, in one or more embodiments, the delayed in-situ recommendation system 106 generates the recommendation 506 with a name, description, image(s), sizing, and other information corresponding to a variety of items selected for in-store viewing.

Further, as shown in FIG. 5, the recommendation 506 includes an accept button 508a and a decline button 508b. In one or more embodiments, in response to receiving an indication of user interaction at the accept button 508a (via the client device 502), the delayed in-situ recommendation system 106 provides instructions for retrieving and reserving the selected item to an administrator device. To illustrate, the delayed in-situ recommendation system 106 provides the instructions for reserving the selected item to an administrator device corresponding to the physical location selected by the user to pick up the user-selected item. In response to receiving an indication of user interaction at the decline button 508b, the delayed in-situ recommendation system 106 removes the recommendation and declines to send instructions to reserve the item.

Each of the components 602-612 of the delayed in-situ recommendation system 106 include software, hardware, or both. For example, the components 602-612 include one or more instructions stored on a computer-readable storage medium and executable by processors of one or more computing devices, such as a client device or server device. When executed by the one or more processors, the computer-executable instructions of the delayed in-situ recommendation system 106 cause the one or more processors to perform the methods described herein. Alternatively, the components 602-612 include hardware, such as a special-purpose processing device to perform a certain function or group of functions. Alternatively, the components 602-612 of the delayed in-situ recommendation system 106 include a combination of computer-executable instructions and hardware.

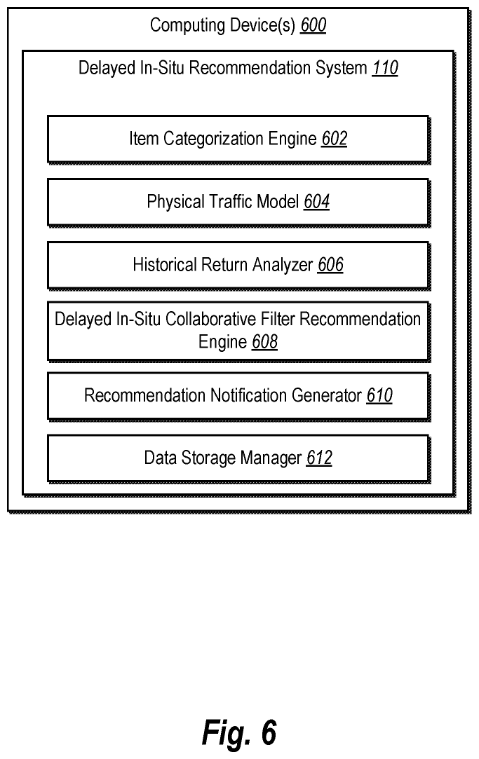

As shown in FIG. 6, the delayed in-situ recommendation system 106 includes an item categorization engine 602. In one or more embodiments, the item categorization engine 602 generates a categorization for user-selected items. In one or more embodiments, the item categorization engine 602 generates and manages clusters of items corresponding to catalogues and/or physical locations. In one or more embodiments, the item categorization engine 602 categorizes items based on historical selection data and/or traffic patterns.

Additionally, as shown in FIG. 6, the delayed in-situ recommendation system 106 includes a physical traffic model 604. In one or more embodiments, the physical traffic model is a predictive model that forecasts traffic for physical store locations. In one or more embodiments, the physical traffic model determines likely foot traffic and patterns of behavior of individuals inside physical locations to determine items that individuals are likely to encounter.

Further, as shown in FIG. 6, the delayed in-situ recommendation system 106 includes a historical return analyzer 606. In one or more embodiments, the historical return analyzer generates a historical return analysis. More specifically, in one or more embodiments, the historical return analyzer 606 identifies items with a high return rate due to the online purchase process. In one or more embodiments, the historical return analyzer 606 identifies these items utilizing survey data indicating reasons for return and/or by comparing a rate of return for the item when purchased online to a rate of return for the item when purchased in-store.

As also shown in FIG. 6, the delayed in-situ recommendation system 106 includes a delayed in-situ collaborative filter recommendation engine 608. In one or more embodiments, the delayed in-situ collaborative filter recommendation engine 608 determines recommendations of items to view in store when picking up a user-selected item to purchase online and pick-up in store. In one or more embodiments, the delayed in-situ collaborative filter recommendation engine receives item categorizations or clusters, physical store traffic modelling, item selection metrics, and/analysis of historical return of items. Accordingly, the delayed in-situ collaborative filter recommendation engine 608 utilizes this data to determine an item for in-store viewing.

In one or more embodiments, the delayed in-situ recommendation system 106 also includes the recommendation notification generator 610. In one or more embodiments, the recommendation notification generator 610 retrieves information corresponding to a recommended item and compiles the information into a recommendation to provide to a user. In one or more embodiments, the recommendation notification generator 610 generates a graphical user interface including data and/or images corresponding to the selected item.

The delayed in-situ recommendation system 106 also includes the data storage manager 612. The data storage manager 612 maintains data for the delayed in-situ recommendation system 106. The data storage manager 612 (e.g., via one or more memory devices) maintains data of any type, size, or kind, as necessary to perform the functions of the delayed in-situ recommendation system 106. For example, the data storage facility 924 includes item categorization, accesses physical store traffic modelling, and/or generates an analysis of historical return of items.

Furthermore, the components 602-612 of the delayed in-situ recommendation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 602-612 may be implemented as a stand-alone application, such as a desktop or mobile application. Furthermore, the components 602-612 may be implemented as one or more web-based applications hosted on a remote server. The components 602-612 may also be implemented in a suite of mobile device applications or “apps.”

To illustrate, the components 602-612 may be implemented in an application, including but not limited to ADOBE® ANALYTICS CLOUD, such as ADOBE® ANALYTICS, ADOBE® AUDIENCE MANAGER, ADOBE® CAMPAIGN, ADOBE® EXPERIENCE MANAGER, and ADOBE® MAGENTO or ADOBE® MARKETING CLOUD. The foregoing are either registered trademarks or trademarks of Adobe Inc. in the United States and/or other countries.

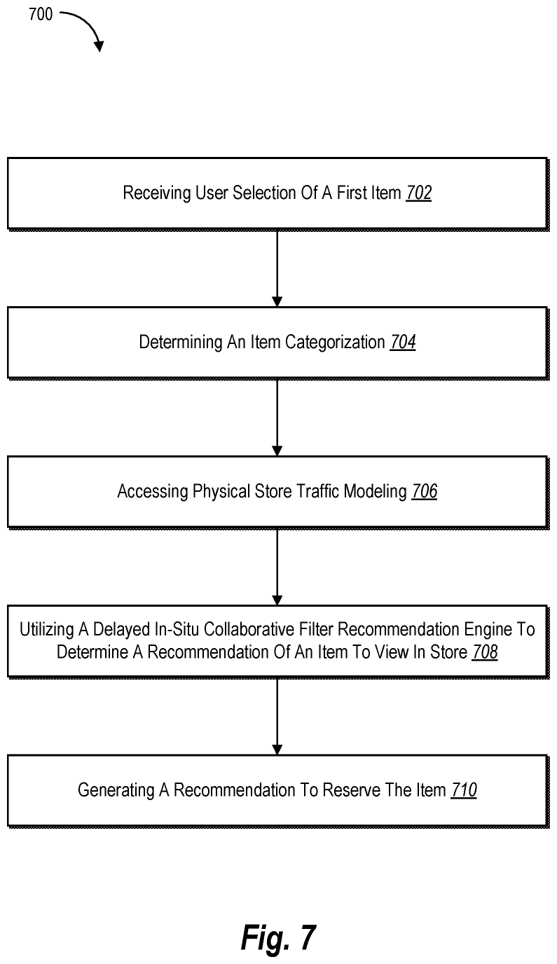

FIGS. 1-6, the corresponding text, and the examples provide a number of different methods, systems, devices, and non-transitory computer-readable media of the delayed in-situ recommendation system 106. In addition to the foregoing, one or more embodiments also are described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for generating a recommendation of an item to view in-store in accordance with one or more embodiments. While FIG. 7 illustrates acts according to one embodiment, alternative embodiments may omit, add to, reorder, and/or modify any of the acts shown in FIG. 7. In one or more implementations, the acts of FIG. 7 are performed as part of a method. Alternatively, a non-transitory computer-readable medium comprises instructions that, when executed by one or more processors, cause the one or more processors to perform the acts of FIG. 7. In one or more embodiments, a system performs the acts of FIG. 7.

As shown in FIG. 7, the series of acts 700 includes an act 702 for receiving user selection of a first item. In particular, the act 702 includes receiving, via a client device, a user selection of a first item to purchase online and pick up in a store. As shown in FIG. 7, the series of acts 700 includes an act 704 for determining an item categorization. In particular, the act 704 includes determining an item categorization of the first item. Specifically, the act 704 includes identifying item categorization by clustering item categories based on similar historical selection patterns, selecting a cluster corresponding to the first item, and utilizing the delayed in-situ collaborative filter recommendation engine to fit a time-series model to the cluster.

As shown in FIG. 7, the series of acts 700 includes an act 706 for accessing physical store traffic modeling. In particular, the act 706 includes accessing physical store traffic modeling for the store and generating an analysis of historical return of items. Specifically, the act 706 includes the physical store traffic modeling generating an item selection metric for items at the store based on a rate of user selection of the items at the store relative to a predicted number of user encounters for the items at the store. Additionally, in one or more embodiments, the act 706 includes determining a traffic prediction model for the second item as a function of a general traffic prediction model for the store and modulating the traffic prediction model for the second item by a time-series traffic forecasting model derived as a function of item clusters. In one or more embodiments, the act 706 also includes wherein the analysis of historical returns comprises determining an overall return rate and an online purchase return rate for the second item.

As shown in FIG. 7, the series of acts 700 includes an act 708 for utilizing a delayed in-situ collaborative filter recommendation engine to determine a recommendation of an item to view in store. In particular, the act 708 includes utilizing a delayed in-situ collaborative filter recommendation engine to determine a recommendation of a second item to view in the store based on the item categorization corresponding to the first item, the physical store traffic modeling, the analysis of historical return of items, and inventory data for the second item. Specifically, the act 708 includes determining the recommendation based on similarities between items at the store and similarities between users associated with the items at the store.

As shown in FIG. 7, the series of acts 700 includes an act 710 for generating a recommendation to reserve the item. In particular, the act 710 includes generating, for presentation via the client device, a recommendation to reserve the second item for in-store viewing based on the recommendation of the second item by the delayed in-situ collaborative filter recommendation engine. Specifically, the act 710 includes receiving user interaction with the recommendation and providing an indication to an administrator device to retrieve the second item.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In one or more embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., the computing device 600, the server(s) 102, the client device(s) 110a-110n). In one or more embodiments, the computing device 800 may be a mobile device (e.g., a mobile telephone, a smartphone, a PDA, a tablet, a laptop, a camera, a tracker, a watch, a wearable device, etc.). In one or more embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, via a client device, a user selection of a first item to purchase online and pick up in a store;
determining an item categorization of the first item;
accessing physical store traffic modeling for the store;
generating an analysis of historical return of items;
utilizing a delayed in-situ collaborative filter recommendation engine to determine a recommendation of a second item to view in the store based on the item categorization corresponding to the first item, the physical store traffic modeling, the analysis of historical return of items, and inventory data for the second item; and
generating, for presentation via the client device, a recommendation to reserve the second item for in-store viewing based on the recommendation of the second item by the delayed in-situ collaborative filter recommendation engine.

2. The computer-implemented method of claim 1, further comprising receiving user interaction with the recommendation and providing an indication to an administrator device to retrieve or reserve the second item.

3. The computer-implemented method of claim 1, further comprising:
identifying item categorization by clustering item categories based on similar historical selection patterns;
selecting a cluster corresponding to the first item; and
utilizing the delayed in-situ collaborative filter recommendation engine to fit a time-series model to the cluster.

4. The computer-implemented method of claim 1, wherein the delayed in-situ collaborative filter recommendation engine determines the recommendation based on similarities between items at the store and similarities between users associated with the items at the store.

5. The computer-implemented method of claim 1, wherein the physical store traffic modeling generates an item selection metric for items at the store based on a rate of user selection of the items at the store relative to a predicted number of user encounters for the items at the store.

6. The computer-implemented method of claim 1, further comprising:
determining a traffic prediction model for the second item as a function of a general traffic prediction model for the store; and
modulating the traffic prediction model for the second item by a time-series traffic forecasting model derived as a function of item clusters.

7. The computer-implemented method of claim 1, wherein the analysis of historical returns comprises determining an overall return rate and an online purchase return rate for the second item.

8. A non-transitory computer-readable medium comprising instructions that, when executed by at least one processor, cause the at least one processor to perform operations comprising:
receiving, via a client device, a user selection of a first item to purchase online and pick up in a store;
determining an item categorization of the first item;
accessing physical store traffic modeling for the store;
determining an item selection metric utilizing a time series model and based on the item categorization and the physical store traffic modeling;
generating an analysis of historical return of items;
utilizing a delayed in-situ collaborative filter recommendation engine to determine a recommendation of a second item to view in the store based on an optimization equation comprising the item selection metric, the analysis of historical return of items, and inventory data for the second item; and
generating, for presentation via the client device, a recommendation to reserve the second item for in-store viewing based on the recommendation of the second item by the delayed in-situ collaborative filter recommendation engine.

9. The non-transitory computer-readable medium of claim 8, wherein the operations further comprise receiving user interaction with the recommendation and providing an indication to an administrator device to retrieve the second item.

10. The non-transitory computer-readable medium of claim 8, wherein the operations further comprise:
identifying item categorization by clustering item categories based on similar historical selection patterns;
selecting a cluster corresponding to the first item; and
utilizing the delayed in-situ collaborative filter recommendation engine to fit a time-series model to the cluster.

11. The non-transitory computer-readable medium of claim 8, wherein the delayed in-situ collaborative filter recommendation engine determines the recommendation based on similarities between items at the store and similarities between users associated with the items at the store.

12. The non-transitory computer-readable medium of claim 8, wherein accessing the physical store traffic modeling comprises generating an item selection metric for items at the store based on a rate of user selection of the items at the store relative to a predicted number of user encounters for the items at the store.

13. The non-transitory computer-readable medium of claim 8, wherein the operations further comprise:
determining a traffic prediction model for the second item as a function of a general traffic prediction model for the store; and
modulating the traffic prediction model for the second item by a time-series traffic forecasting model derived as a function of item clusters.

14. The non-transitory computer-readable medium of claim 8, wherein generating the analysis of historical returns comprises determining an overall return rate and an online purchase return rate for the second item.

15. A system comprising:
one or more memory devices comprising a client device and a delayed in-situ collaborative filter recommendation engine; and
one or more processors configured to cause the system to:
receive, via a client device, a user selection of a first item to purchase online and pick up in a store;
determine an item categorization of the first item;
access physical store traffic modeling for the store;
determine an item selection metric utilizing a time series model and based on the item categorization and the physical store traffic modeling;
generate an analysis of historical return of items;
utilize the delayed in-situ collaborative filter recommendation engine to determine a recommendation of a second item to view in the store based on an optimization equation comprising the item selection metric, the analysis of historical return of items, and inventory data for the second item; and
generate, for presentation via the client device, a recommendation to reserve the second item for in-store viewing based on the recommendation of the second item by the delayed in-situ collaborative filter recommendation engine.

16. The system of claim 15, wherein the one or more processors are further configured to cause the system to receive user interaction with the recommendation and providing an indication to an administrator device to retrieve the second item.

17. The system of claim 15, wherein the one or more processors are further configured to cause the system to:
identify item categorization by clustering item categories based on similar historical selection patterns;
select a cluster corresponding to the first item; and
utilize the delayed in-situ collaborative filter recommendation engine to fit a time-series model to the cluster.

18. The system of claim 15, wherein the delayed in-situ collaborative filter recommendation engine determines the recommendation based on similarities between items at the store and similarities between users associated with the items at the store.

19. The system of claim 15, wherein accessing the physical store traffic modeling comprises generating an item selection metric for items at the store based on a rate of user selection of the items at the store relative to a predicted number of user encounters for the items at the store.

20. The system of claim 15, wherein the one or more processors are further configured to cause the system to:
determine a traffic prediction model for the second item as a function of a general traffic prediction model for the store; and
modulate the traffic prediction model for the second item by a time-series traffic forecasting model derived as a function of item clusters.
